(19) United States
(12) Patent Application Publication
(10) Pub. No.: US 2024/0407443 A1
(43) Pub. Date: Dec. 12, 2024

(54) AEROSOL GENERATING DEVICE

(71) Applicant: KT&G CORPORATION, Daejeon (KR)

(72) Inventors: Jongsub LEE, Sungnam-si, Gyeonggi-do (KR); Daenam HAN, Seoul (KR); Sangkyu PARK, Seoul (KR); Wooseok CHUNG, Namyangju-si, Gyeonggi-do (KR); Byungsung CHO, Gwangmyung-si, Gyeonggi-do (KR)

(73) Assignee: KT&G CORPORATION, Daejeon (KR)

(21) Appl. No.: 18/698,291

(22) PCT Filed: Oct. 18, 2022
(86) PCT No.: PCT/KR2022/015827

§ 371 Date: Apr. 3, 2024

(30) Foreign Application Priority Data
Oct. 19, 2021 (KR) 10-2021-0139800
Oct. 19, 2021 (KR) 10-2021-0139806
Feb. 4, 2022 (KR) 10-2022-0014699
Feb. 11, 2022 (KR) 10-2022-0018358

(51) Int. Cl. A24F 40/46; A24D 3/17; A24F 40/10; A24F 40/44

(52) U.S. Cl. CPC A24F 40/46; A24D 3/17; A24F 40/10; A24F 40/44

(57) ABSTRACT

An aerosol generating device is provided. The aerosol generating device according to the present disclosure includes: a container comprising an inner wall and an outer wall surrounding the inner wall and containing a liquid between the inner wall and the outer wall, wherein the inner wall is shaped to define an elongated insertion space; a wick having a portion that is disposed between the inner wall and the outer wall to absorb the liquid; a heater disposed around at least a portion of the wick and being configured to heat the wick; a base defining an inner space that communicates with the insertion space and is disposed at one side of the container in a longitudinal direction of the insertion space, wherein the base includes a side wall that is shaped to define an inlet communicating with the inner space of the base; and a filter disposed inside the base and covering the inlet.

### TECHNICAL FIELD

The following description relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component, and the like. Recently, the aerosol generating device is actively researched.

### DISCLOSURE

### Technical Problem

It is an objective of the present disclosure to solve the above and other problems.

It is another objective of the present disclosure to minimize leakage of aerosol, generated in a cartridge, to the outside of the cartridge.

It is yet another objective of the present disclosure to provide a structure in which a cartridge and a filter may be integrally replaced.

It is yet another objective of the present disclosure to provide a structure in which the cartridge and a absorbing body for absorbing droplets may be integrally replaced.

It is yet another objective of the present disclosure to provide a structure in which the absorbing body is mounted in the cartridge.

### Technical Solution

In accordance with an aspect of the present disclosure for accomplishing the above objectives, there is provided an aerosol generating device including: a container comprising an inner wall and an outer wall surrounding the inner wall and containing a liquid between the inner wall and the outer wall, wherein the inner wall is shaped to define an elongated insertion space; a wick having a portion that is disposed between the inner wall and the outer wall to absorb the liquid; a heater disposed around at least a portion of the wick and being configured to heat the wick; a base defining an inner space that communicates with the insertion space and is disposed at one side of the container in a longitudinal direction of the insertion space, wherein the base includes a side wall that is shaped to define an inlet communicating with the inner space of the base; and a filter disposed inside the base and covering the inlet.

In accordance with another aspect of the present disclosure for accomplishing the above objectives, there is provided an aerosol generating device including: a container including an elongated inner wall that is shaped to define an insertion space, and an outer wall surrounding the inner wall and being shaped to contain a liquid between the inner wall and the outer wall; a wick having a portion that is disposed between the inner wall and the outer wall; a heater disposed around at least a portion of the wick and being configured to heat the wick; a base disposed adjacent to the heater and coupled to the container, an inside of the base communicating with the insertion space; and an absorbing body disposed in the base.

### Advantageous Effects

According to at least one of the embodiments of the present disclosure, an aerosol generating device may be manufactured in a compact size.

According to at least one of the embodiments of the present disclosure, it is possible to minimize leakage of aerosol to the outside of the cartridge in which the aerosol is generated.

According to at least one of the embodiments of the present disclosure, a filter is mounted in a cartridge, such that the cartridge and the filter may be integrally replaced.

According to at least one of the embodiments of the present disclosure, a absorbing body is mounted in the cartridge, such that the cartridge and the absorbing body may be integrally replaced.

Further scope of applicability of the present disclosure will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### DESCRIPTION OF DRAWINGS

FIGS. 1 to 7 are diagrams illustrating examples of an aerosol generating device according to an embodiment of the present disclosure.

FIGS. 8 to 15 are diagrams illustrating examples of an aerosol generating device according to an embodiment of the present disclosure.

### MODE FOR INVENTION

Hereinafter, embodiments of the present disclosure will be described in detail with reference to the accompanying drawings, in which the same or similar elements are designated by the same reference numerals, and a redundant description thereof will be omitted.

The terms “module” and “unit” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings, and the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms are intended to include the plural forms as well, unless the context clearly indicates otherwise.

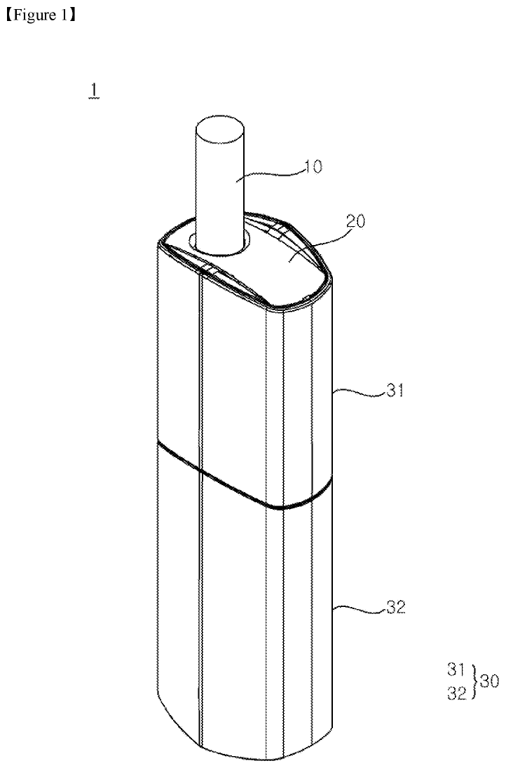

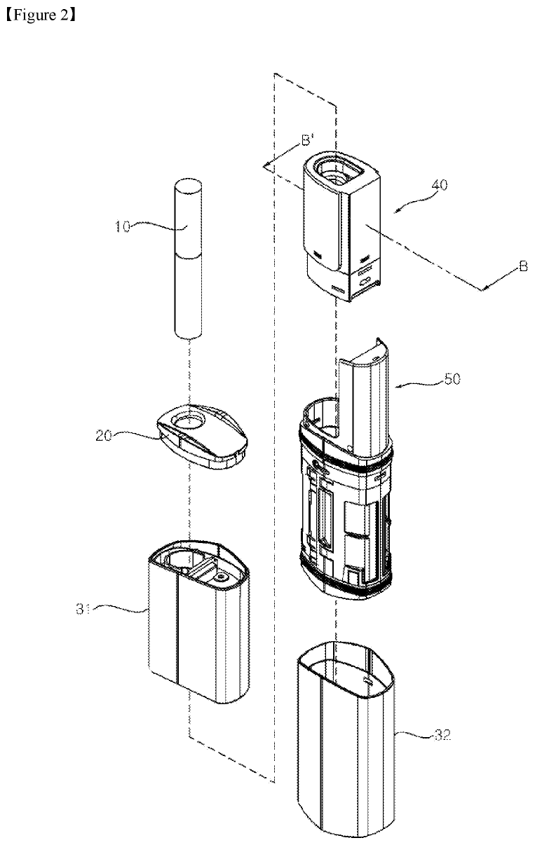

FIG. 1 is a perspective view of an aerosol generating device 1 according to an embodiment of the present disclosure. FIG. 2 is an exploded perspective view of the aerosol generating device 1 of FIG. 1.

Referring to FIGS. 1 and 2, the aerosol generating device 1 may comprise: a casing 30 including an upper part 31 and a lower part 32; a cap 20 coupled to the upper part 31; a cartridge 40 which is disposed in the casing 30 and in which aerosol is generated; and a main body 50 which is disposed in the casing 30, and in which the cartridge is mounted. A stick 10 may be inserted into the aerosol generating device 1 through the cap 20.

The casing 30 may form the exterior of the aerosol generating device 1 along with the cap 20. The casing 30 may include the upper part 31 and the lower part 32. The upper part 31 and the lower part 32 may surround the circumference of the aerosol generating device 1. The cartridge 40 and the main body 50 may be disposed in the casing 30. An inner surface of the upper part 31 may be coupled to an outer surface of the cartridge 40. An inner surface of the lower part 32 may be coupled to an outer surface of the main body 50. When the upper part 31 and the lower part 32 are coupled to the cartridge 40 and the main body 50 respectively, the upper part 31 and the lower part 32 may form a continuous surface. A user may hold the aerosol generating device 1 by gripping an outer surface of the casing 30.

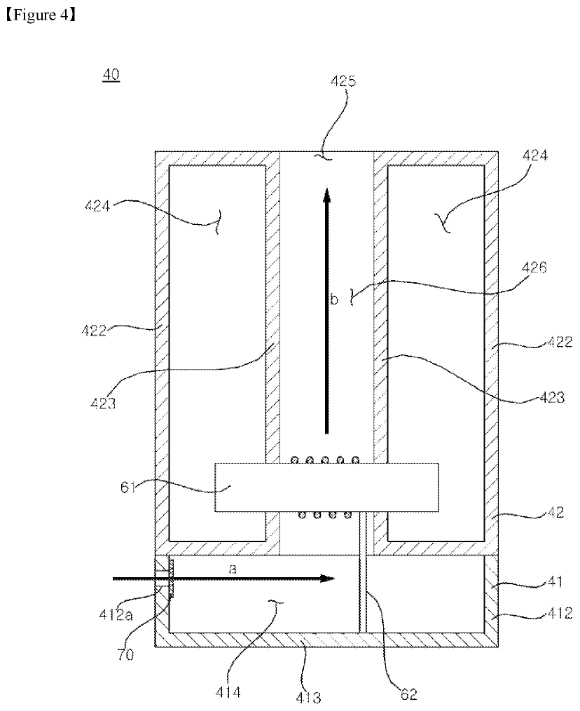

The cap 20 may have a hole through which the stick 10 is inserted. The cap 20 may be coupled to the upper part 31. The hole of the cap 20 may communicate with an insertion space 426 (see FIG. 4) into which the stick 10 is inserted. The cap 20 may open and close the hole through which the stick 10 is inserted. The upper part 31 may be disposed between the cap 20 and the lower part 32.

An aerosol may be generated in the cartridge 40. The cartridge 40 may be detachably coupled to the main body 50. The cartridge 40 and the main body 50 may be coupled to each other by forced coupling of protrusions and grooves. The cartridge 40 may have an elongated shape. An opening 425 (see FIG. 4), through which the stick 10 is inserted, may be formed at one end of the cartridge 40. The cartridge 40 may be covered by the casing 30.

Electronic components, such as a battery, a PCB, etc., may be installed in the main body 50. When the cartridge 40 is mounted to the main body 50, the main body 50 may be electrically connected to the cartridge 40. The main body 50 may include a power supply (not shown) for supplying power to the cartridge 40. The main body 50 may have a shape which is elongated in a longitudinal direction of the cartridge. The main body 50 may be covered by the casing 30.

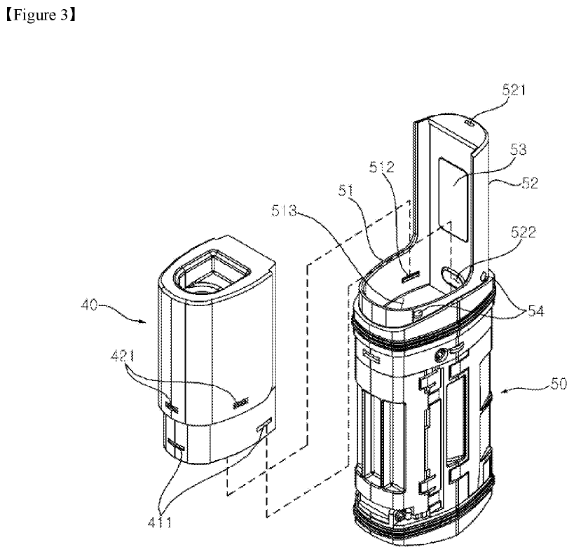

FIG. 3 is an exploded perspective view illustrating a connection relationship between the cartridge 40 and the main body 50. Referring to FIG. 3, the cartridge 40 may be mounted to the main body 50 and may be removed from the main body 50.

The cartridge 40 may have a groove 411 formed in an outer surface thereof. The main body 50 may have a protrusion 512 coupled to the groove 411 of the cartridge 40 and formed on an outer surface of the main body 50. The cartridge 40 may have a plurality of grooves 411, and the main body 50 may have a plurality of protrusions 512. Unlike this embodiment, a protruding portion may be formed on the cartridge 40, and a recessed portion, in which the protruding portion is received, may be formed in the main body 50.

The cartridge 40 may have a groove 421 formed in the outer surface thereof. The casing 30 may be coupled to the groove 421 of the cartridge 40. The groove 421 of the cartridge 40 may be coupled to the upper part 31 of the casing 30.

The main body 50 may have a protrusion 54 formed on the outer surface thereof. The casing 30 may be coupled to the protrusion 54 of the main body 50. The protrusion 54 of the main body 50 may be coupled to the upper part 31 of the casing 30.

A mounting portion 51, in which the cartridge 40 is mounted, and a column 52, which has a hollow shape and is formed on one side of the mounting portion 51, may be disposed at an outer end of the main body 50 in a longitudinal direction of the cartridge 40.

The mounting portion 51 may define a space 513 which is recessed into the main body 50, and in which the cartridge 40 is inserted and mounted. The protrusion 512 may be formed on an inner surface of the mounting portion 51. The column 52 may be disposed on one side of the mounting portion 51.

The column 52 may be elongated in the longitudinal direction of the cartridge 40. The column 52 may have a hollow shape. The column 52 may support a lateral surface of the cartridge 40. The column 52 may define the space 513, in which the cartridge 40 is mounted, along with the mounting portion 51.

The column 52 may include a sensing unit 53 and through-holes 521 and 522. The column 52 has a hollow shape such that electronic components, such as a sensor, a PCB, etc., may be mounted therein. The sensing unit 53 is disposed to face the cartridge 40 to detect the presence of a liquid in the cartridge 40, a remaining amount of the liquid, and the like. The through-hole 521 may communicate with the outside of the aerosol generating device 1. The through-holes 521 and 522 may communicate with each other through an inner space of the column 52. Air outside of the aerosol generating device 1 may sequentially pass through the inner space of the column 52, the through-holes 521 and 522, and an inlet 412a (see FIG. 4), to be introduced into the cartridge 40.

FIG. 4 is a cross-sectional view of the cartridge 40 taken along line B-B′ of FIG. 2. Referring to FIG. 4, the cartridge 40 may comprise a container 42, a base 41, a wick 61, and a heater 62, and a filter 70 may be disposed in the cartridge 40.

The container 42 may include an insertion space 426 into which the stick 10 is inserted, an inner wall 423 which is elongated and defines the insertion space 426, an outer wall 422 surrounding the inner wall 423 and elongated in a longitudinal direction of the inner wall 423, and a storage space 424 which is disposed between the inner wall 423 and the outer wall 422 and in which a liquid is contained.

The inner wall 423 and the outer wall 422 of the container 42 may be formed in a cylindrical shape. The outer wall 422 may surround the inner wall 423. The inner wall 423 may be disposed within the outer wall 422. The inner wall 423 and the outer wall 422 may extend in the longitudinal direction of the cartridge 40. A liquid vaporized to form an aerosol may be stored between the outer wall 422 and the inner wall 423. The inner wall 423 and the outer wall 422 of the container 42 may be formed of a translucent or transparent material. The insertion space 426 may be disposed inside the inner wall 423. As the insertion space 426 is disposed inside the inner wall 423, the aerosol generating device 1 may be manufactured in a compact size, compared to the case where the insertion space 426 is provided outside of the container 42.

The insertion space 426 may be disposed inside the cartridge 40. The insertion space 426 may communicate with the outside of the cartridge 40 through an opening 425 formed at one end of the container 42. The insertion space 426 may be surrounded by the inner wall 423. The insertion space 426 may have a cylindrical shape. The aerosol, vaporized by the heater 62, may flow (b) to the outside of the cartridge 40 through the insertion space 426 and the opening 425.

The base 41 may be provided at one side of the container 42. The base 41 may be provided at one side of the container 42 in the longitudinal direction of the cartridge 40. The base 41 may be disposed at a position adjacent to the wick 61. The base 41 may include a bottom 413, a side wall 412, and an inner space 414.

The bottom 413 of the base 41 may be disposed opposite the insertion space 426 with respect to the wick 61. The bottom 413 of the base 41 may face the opening 425 of the container 42. The side wall 412 of the base 41 may extend from the bottom 413 toward the container 42. The side wall 412 of the base 41 may be connected to the container 42. The heater 62 may be electrically connected to the power supply of the main body 50 by the bottom 413. The inlet 412a may be formed in the side wall 412 of the base 41.

The inlet 412a may be open through the side wall 412 of the base 41. The inlet 412a may be open in a direction perpendicular to an inner surface of the base 41. The inlet 412a may communicate with the through-hole 522. Air introduced through the inlet 412a may flow (a) to the wick 61.

The inlet 412a may be formed between the container 42 and the bottom 413 of the base 41 in the longitudinal direction of the cartridge 40. The inlet 412a may be disposed closer to the container 42 than to the bottom 413 of the base 41.

The inner space 414 of the base 41 may communicate with a space around the wick 61 and the insertion space 426. A liquefied aerosol may remain in the inner space 414. The inner space 414 may provide a passage connecting the space around the wick 61 with the outside of the cartridge 40.

The wick 61 may be connected to the inside of the container 42. A portion of the wick 61 may be disposed inside the container 42, and another portion thereof may be connected or extend to the liquid contained between the inner wall 423 and the outer wall 422. The wick 61 may be partially inserted into the storage space 424. The wick 61 may pass through the inner wall 423 of the container 42 to be connected to the inside of the storage space 424. The wick 61 may be disposed between the insertion space 426 and the inner space 414 of the base 41. The wick 61 may absorb the liquid contained in the storage space 424.

The heater 62 may be formed as a wire which is elongated and through which electricity flows. The heater 62 may be wound several times around the wick 61. The heater 62 may generate heat to vaporize the liquid absorbed into the wick 61. The heater 62 may be disposed on an outer surface of the base 41 through the inner space 414 of the base 41. Alternatively, the heater 62 may pass through the inner space 414 of the base 41 to extend to the outside of the base 41. The heater 62 may be supplied with power from the battery mounted in the main body 50.

The filter 70 may filter out aerosol contained in the air. The filter 70 may minimize leakage of aerosol to the outside of the cartridge 40. The filter 70 may be disposed on an inner surface of the base 41. The filter 70 may collide with aerosol g flowing in the inner space 414 of the base 41. After colliding with the filter 70, the aerosol may be liquefied and formed on the filter 70.

The filter 70 and the cartridge 40 may be integrally removed from the main body 50. The filter 70 and the cartridge 40 may be integrally replaced. After absorbing a large amount of aerosol, the filter 70 may be replaced along with the cartridge 40. The filter 70 may be made of a material having absorptivity corresponding to an amount of aerosol stored in the container 42.

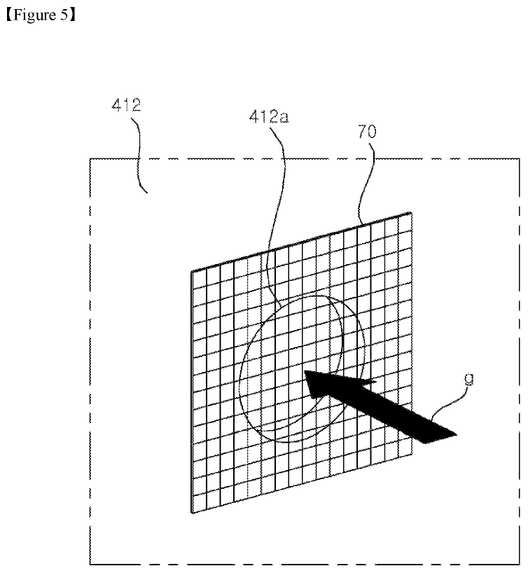

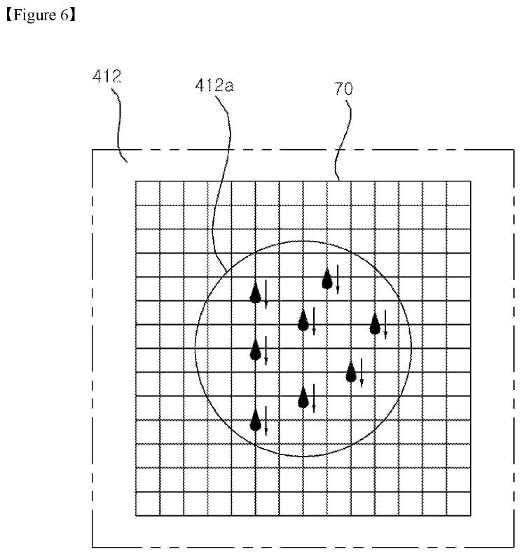

FIGS. 5 and 6 are diagrams illustrating the filter 70 as seen from the inner space 414 of the base 41.

Referring to FIGS. 5 and 6, the filter 70 may be formed by weaving a plurality of strings. For example, the filter 70 may have a mesh shape or a net shape. Air may flow through the plurality of strings of the filter 70. For example, the plurality of strings may have an interval of 1 mm to 2 mm but are not limited thereto.

The filter 70 may be disposed to face the inlet 412a. The filter 70 may cover at least a portion of the inlet 412a. The aerosol liquefied after colliding with the filter 70 may move to one side by gravity. FIG. 6 illustrates an example in which the liquefied aerosol moves downward by gravity.

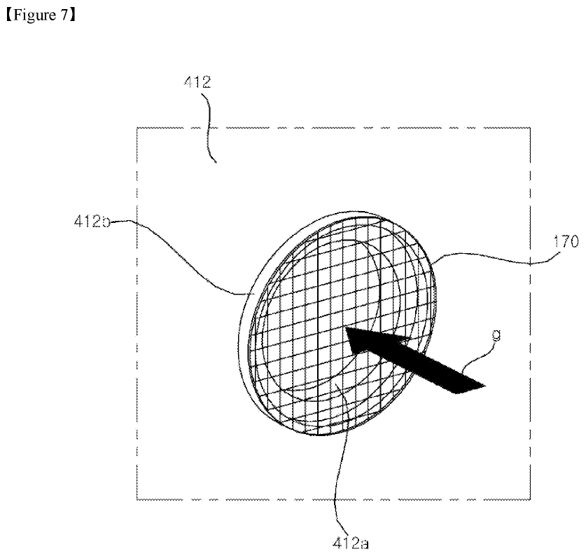

FIG. 7 is a diagram illustrating a filter 170 and a rib 412b supporting the filter 170 according to an embodiment of the present disclosure.

Referring to FIG. 7, the base 41 may include a rib 412b protruding from an inner surface thereof and extending along a circumference of the inlet 412a.

The rib 412b may protrude from the inner surface of the base 41. For example, the rib 412b may protrude in a direction perpendicular to the inner surface of the base 41. The rib 412b may be formed in an annular shape. However, the shape of the rib 412b is not limited to the annular shape, and another shape may also be applied. The rib 412b may surround the inlet 412a. The rib 412b may be spaced apart from the circumference of the inlet 412a in a radially outward direction of the inlet 412a. The rib 412b may protrude uniformly from the inner surface of the base 41 by a predetermined length. The rib 412b may have a cylindrical shape.

The filter 170 may be mounted to the rib 412b. The filter 10 may be in contact with the rib 412b. The filter 170 may be adhered to the rib 412b. The filter 170 may be adhered to an outer circumferential surface of the rib 412b. The filter 170 may be spaced apart from the inlet 412a. The aerosol g flowing in the inner space 414 of the base 41 may be liquefied by colliding with the filter 170 and may move downward by gravity.

The aerosol liquefied by colliding with the filters 70 and 170 may move downward by gravity and may be stored in the inner space 414 of the base. Accordingly, it is possible to minimize leakage of the aerosol, generated in the cartridge 40, to the outside of the cartridge 40 through the inlet 412a.

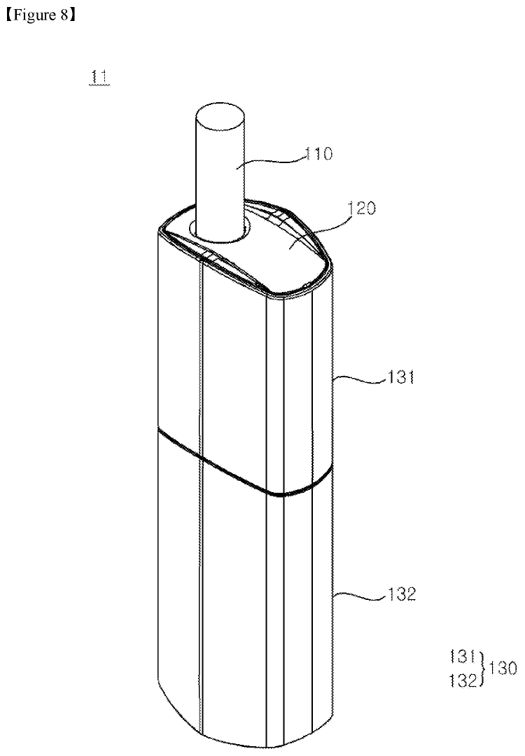

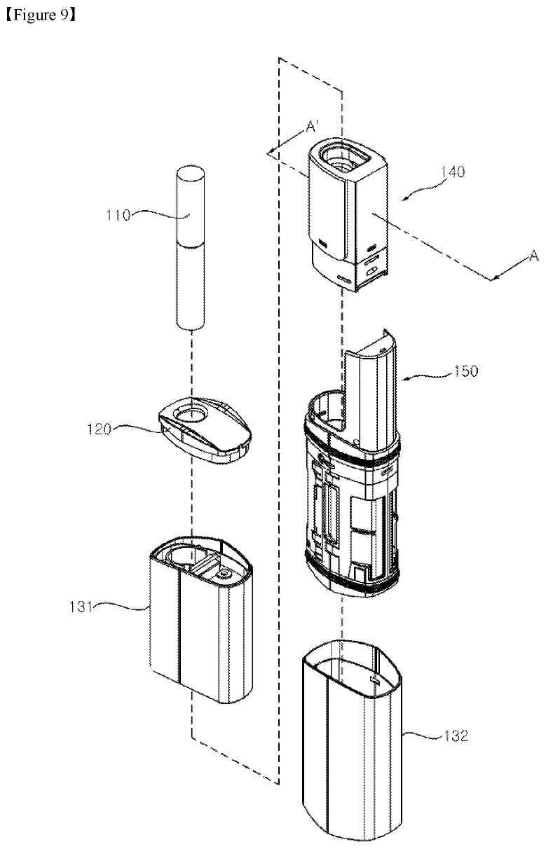

FIG. 8 is a perspective view of an aerosol generating device 11 according to an embodiment of the present disclosure. FIG. 9 is an exploded perspective view of the aerosol generating device 11 of FIG. 8.

Referring to FIGS. 8 and 2, the aerosol generating device 11 may comprise: a casing 130 including an upper part 131 and a lower part 132; a cap 120 coupled to the upper part 131; a cartridge 140 which is disposed in the casing 130, and in which aerosol is generated; and a main body 150 which is disposed in the casing 130, and in which the cartridge is mounted. A stick 110 may be inserted into the aerosol generating device 11 through the cap 120.

The casing 130 may form the exterior of the aerosol generating device 11 along with the cap 120. The casing 130 may include the upper part 131 and the lower part 132. The upper part 131 and the lower part 132 may surround a periphery of the aerosol generating device 11. The cartridge 140 and the main body 150 may be disposed in the casing 30. An inner surface of the upper part 131 may be coupled to an outer surface of the cartridge 140. An inner surface of the lower part 132 may be coupled to an outer surface of the main body 150. When the upper part 131 and the lower part 32 are coupled to the cartridge 140 and the main body 150 respectively, the upper part 131 and the lower part 132 may form a continuous surface. A user may hold the aerosol generating device 1 by gripping an outer surface of the casing 30.

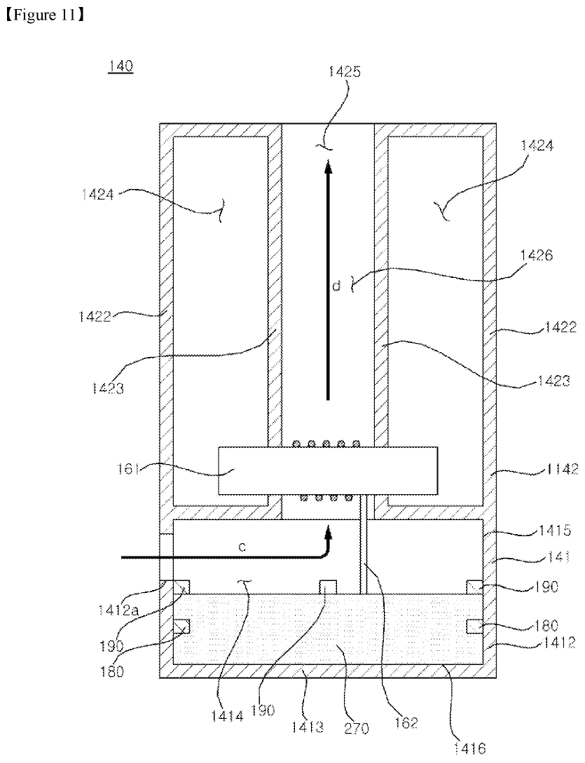

The cap 120 may have a hole into which the stick 110 is inserted. The cap 120 may be coupled to the upper part 131. The hole of the cap 120 may communicate with an insertion space 1426 (see FIG. 11) into which the stick 110 is inserted. The cap 120 may open and close the hole into which the stick 110 is inserted. The upper part 131 may be disposed between the cap 120 and the lower part 132.

Aerosol may be generated in the cartridge 140. The cartridge 140 may be detachably coupled to the main body 150. The cartridge 140 and the main body 150 may be coupled to each other by forced coupling of protrusions and grooves. The cartridge 140 may have an elongated shape. An opening 1425 (see FIG. 11), into which the stick 110 is inserted, may be formed at one end of the cartridge. The cartridge 140 may be covered by the casing 130.

Electronic components, such as a battery, a PCB, etc., may be installed in the main body 150. When the cartridge 140 is mounted to the main body 150, the main body 150 may be electrically connected to the cartridge 140. The main body 150 may include a power supply (not shown) for supplying power to the cartridge 140. The main body 150 may have a shape which is elongated in a longitudinal direction of the cartridge. The main body 150 may be covered by the casing 130.

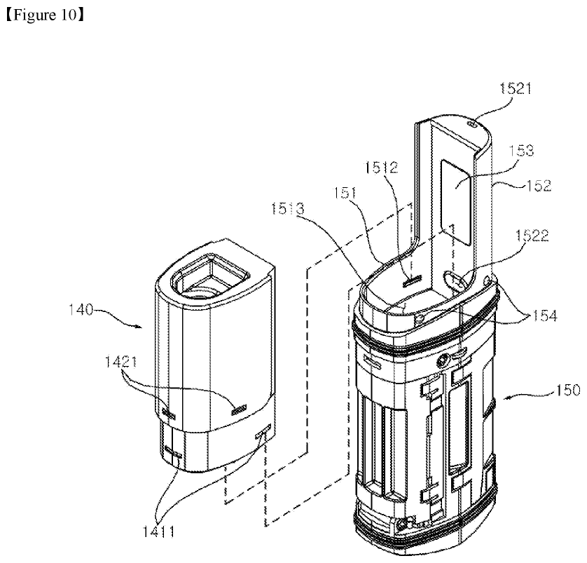

FIG. 10 is an exploded perspective view illustrating a connection relationship between the cartridge 140 and the main body 150. Referring to FIG. 10, the cartridge 140 may be mounted to the main body 150 and may be removed from the main body 150.

The cartridge 140 may have a groove 1411 formed in an outer surface thereof. A protrusion 1512 coupled to the groove 411 of the cartridge 140 may be formed on the outer surface of the main body 150. The cartridge 140 may have a plurality of grooves 1411, and the main body 150 may have a plurality of protrusions 1512. Unlike this embodiment, a protruding portion may be formed on the cartridge 140, and a recessed portion, in which the protruding portion is received, may be formed in the main body 150.

The cartridge 140 may have a groove 1421 formed in the outer surface thereof. The casing 130 may be coupled to the groove 1421 of the cartridge 140. The groove 1421 of the cartridge 140 may be coupled to the upper part 131 of the casing 130.

The main body 150 may have a protrusion 154 formed on the outer surface thereof. The casing 130 may be coupled to the protrusion 154 of the main body 150. The protrusion 154 of the main body 150 may be coupled to the upper part 131 of the casing 130.

A mounting portion 151, in which the cartridge 140 is mounted, and a column 152, which has a hollow shape and is disposed on one side of the mounting portion 151, may be provided at an outer end of the main body 150 in a longitudinal direction of the cartridge 40.

The mounting portion 151 may define a space 1513 which is recessed into the main body 150, and in which the cartridge 140 is inserted and mounted. The protrusion 1512 may be formed on an inner surface of the mounting portion 151. The column 152 may be provided on one side of the mounting portion 151.

The column 152 may be elongated in a longitudinal direction of the cartridge 140. The column 152 may have a hollow shape. The column 152 may support a lateral surface of the cartridge 140. The column 152 may define the space 1513, in which the cartridge 140 is mounted, along with the mounting portion 151.

The column 152 may include a sensing unit 153 and through-holes 1521 and 1522. The column 152 has a hollow shape such that electronic components, such as a sensor, a PCB, etc., may be mounted therein. The sensing unit 153 is disposed to face the cartridge 140 to detect the presence of a liquid in the cartridge 140, a remaining amount of the liquid, and the like. The through-hole 1521 may communicate with the outside of the aerosol generating device 11. The through-holes 1521 and 1522 may communicate with each other through an inner space of the column 152. Air outside of the aerosol generating device 11 may sequentially pass through the inner space of the column 152, the through-holes 1521 and 1522, and an inlet 1412a (see FIG. 11), to flow into the cartridge 140.

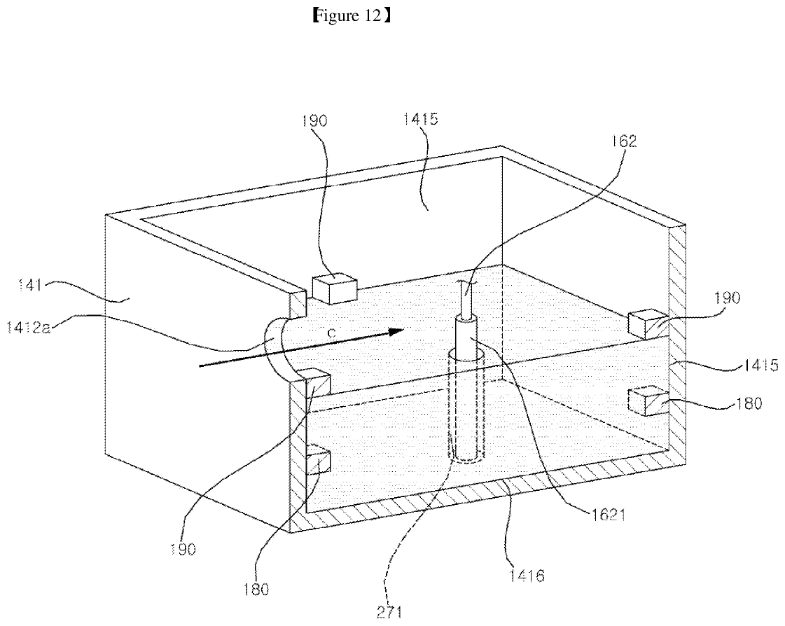

FIG. 11 is a cross-sectional view of the cartridge 140 taken along line A-A′ of FIG. 9. FIG. 12 is a perspective cross-sectional view of a base 145 and an inside of the base 145 of FIG. 11. Referring to FIG. 11, the cartridge 140 may comprise a container 142, a base 141, a wick 161, and a heater 162, and a absorbing body 270 may be disposed in the cartridge 140.

The container 142 may include an insertion space 1426 in which the stick 110 is inserted, an inner wall 1423 which is elongated and defines the insertion space 1426, an outer wall 1422 surrounding the inner wall 1423 and elongated in a longitudinal direction of the inner wall 1423, and a storage space 1424 which is disposed between the inner wall 1423 and the outer wall 1422 and in which a liquid is contained.

The inner wall 1423 and the outer wall 1422 of the container 142 may be formed in a cylindrical shape. The outer wall 1422 may surround the inner wall 1423. The inner wall 1423 may be disposed within the outer wall 1422. The inner wall 1423 and the outer wall 1422 may extend in the longitudinal direction of the cartridge 140. A liquid atomized to form an aerosol may be contained between the outer wall 1422 and the inner wall 1423. The inner wall 1423 and the outer wall 1422 of the container 142 may be made of a translucent or transparent material. The insertion space 1426 may be disposed inside of the inner wall 1423. As the insertion space 1426 is formed inside the inner wall 1423, the aerosol generating device 11 may be manufactured in a compact size, compared to the case where the insertion space 1426 is formed outside of the container 142.

The insertion space 1426 may be formed inside the cartridge 140. The insertion space 1426 may communicate with the outside of the cartridge 140 through an opening 1425 formed at one end of the container 142. The insertion space 1426 may be surrounded by the inner wall 1423. The insertion space 1426 may have a cylindrical shape. The aerosol, atomized by the heater 162, may flow (d) to the outside of the cartridge 140 through the insertion space 426 and the opening 425.

The base 141 may be provided at one side of the container 142. The base 141 may be provided at one side of the container 142 in the longitudinal direction of the cartridge 140. The base 141 may be disposed at a position adjacent to the wick 161. The base 141 may include a bottom 1413, a side wall 1412, an inner space 1414, an inlet 137, a holder 190, and a protrusion 180.

The bottom 1413 of the base 141 may be disposed opposite the insertion space 1426 with respect to the wick 161. The bottom 1413 of the base 141 may face the opening 1425 of the container 142. The side wall 1412 of the base 141 may extend from the bottom 1413 toward the container 142. The side wall 1412 of the base 141 may be connected to the container 142. The heater 162 may be electrically connected to the power supply of the main body 150 through the bottom 1413. For example, by using a contact pin structure, the heater 162 and the main body 159 may come into contact with each other to be electrically connected to each other.

The inlet 1412a may be formed in the side wall 1412 of the base 141. The inlet 1412a may be open through the side wall 412 of the base 41. The inlet 412a may be open in a direction perpendicular to an inner surface of the base 141. The inlet 1412a may communicate with the through-hole 1522. Air introduced through the inlet 1412a may flow (c) to the wick 161.

The inlet 1412a may be formed between the container 142 and the bottom 1413 of the base 141 in the longitudinal direction of the cartridge 140. The inlet 1412a may be disposed closer to the container 142 than to the bottom 1413 of the base 141.

The inner space 1414 of the base 141 may communicate with a space around the wick 161 and the insertion space 1426. A liquefied aerosol may remain in the inner space 1414. The inner space 1414 may provide a passage connecting the space around the wick 61 with the outside of the cartridge 140.

The absorbing body 270 may be disposed in the inner space 148 of the base 145. The absorbing body 270 may absorb the aerosol atomized by the heater 162 and flowing in the inner space 148 of the base 145. For example, the absorbing body 270 may be made of a cotton or sponge material. The absorbing body 270 according to an embodiment of the present disclosure may have a cubic shape and may be inserted into the base 145, but the shape of the absorbing body 270 is not limited to the cubic shape.

The absorbing body 270 may be spaced apart from the wick 161. A wick 192 may be disposed between the absorbing body 270 and the insertion space 143. An outer surface of the absorbing body 270 may face the wick 192. The absorbing body 270 may absorb droplets falling from the wick 192.

The absorbing body 270 may be fixed to the inside of the base 145. Movement of the absorbing body 270 in the base 145 may be restricted by the holder 190 and the protrusion 180. A separation distance between the absorbing body 270 and the wick 192 may be maintained by the holder 190 and the protrusion 180. Accordingly, it is possible to prevent the absorbing body 270 from being melted by the heat from the heater 191.

The holder 190 may be provided on an inner surface 1461 of the base 145. The holder 190 may protrude from the inner surface 1461 of the base 145. When the absorbing body 270 is inserted into the base 145, the holder 190 may be disposed outside of the absorbing body 270. The holder 190 may support an outer surface of the absorbing body 270. The holder 190 may come into contact with the outer surface of the absorbing body 270. The holder 190 may press the outer surface of the absorbing body 270. A plurality of holders 190 may be provided which are arranged along an inner circumference of the base 145. The holder 190 has a curved end portion, thereby minimizing friction with the absorbing body 270.

The protrusion 180 may be provided on the inner surface 1461 of the base 145. The protrusion 180 may protrude from the inner surface 1461 of the base 145. The protrusion 180 may be inserted into the absorbing body 270. The protrusion 180 may be disposed between the holder 190 and the inner surface 1462 of the base 145.

The protrusion 180 may protrude from the inner surface 1461 of the base 145 in the same direction as the holder 190. A protruding length of the protrusion 180 may be different from a protruding length of the holder 190. The protruding length of the protrusion 180 may be greater than the protruding length of the holder 190.

In this embodiment of the present disclosure, both the holder 190 and the protrusion 180 are included, but a different embodiment may also be provided. That is, only the protrusion 180 may be provided without the holder 190, or only the holder 190 may be provided without the protrusion 180.

The wick 161 may be connected to the inside of the container 142. A portion of the wick 161 may be disposed inside the container 142, and another portion thereof may be connected or extend to the liquid contained between the inner wall 1423 and the outer wall 1422. The wick 161 may be partially inserted into the storage space 1424. The wick 161 may pass through the inner wall 1423 of the container 142 to be connected to the inside of the storage space 1424.

The wick 161 may be disposed between the insertion space 1426 and the inner space 1414 of the base 141. The wick 161 may absorb the liquid contained in the storage space 1424. The wick 161 may be disposed inside the inner wall 1423 of the container 142. The wick 161 may be disposed at one end of the inner wall 1423 in the longitudinal direction of the cartridge 140.

The heater 162 may be formed as a wire, which is elongated and through which electricity flows. The heater 162 may be wound several times around the wick 161. The heater 162 may generate heat to vaporize the liquid absorbed into the wick 161. The heater 162 may be disposed on an outer surface of the base 141 through the inner space 1414 of the base 141. Alternatively, the heater 162 may pass through the inner space 1414 of the base 141 to extend to the outside of the base 141. The heater 162 may be supplied with power from the battery mounted in the main body 150.

Referring to FIG. 12, the aerosol generating device 11 may include an insulating member 1621 covering the heater 162.

The insulating member 1621 may cover a portion of the heater 162. The insulating member 1621 may cover a portion of the heater 162 that passes through the absorbing body 270. The absorbing body 270 may have hole 271, in which the insulating member 1621 is disposed. The heater 162 may pass through the hole 271, and the insulating member 1621 may be disposed in the hole 271 to cover the heater 162. The insulating member 1621 may prevent heat, generated by the heater 162, from melting the absorbing body 270.

The insulating member 1621 may be disposed in the hole 271 in a diameter direction of the hole 271. The insulating member 1621 may be spaced inwardly from an inner surface of the hole 271. The heat generated by the heater 16 may pass through the insulating member 1621 and an air layer formed between the hole 217 and the insulating member 1621, to be transferred to the absorbing body 270, thereby preventing the absorbing body 270 from being melted by the heat generated by the heater 162.

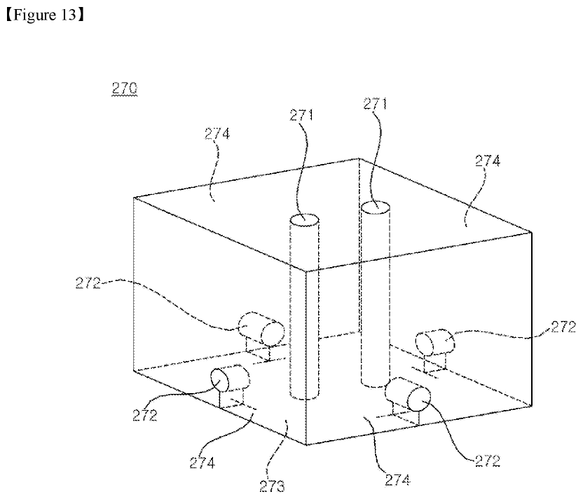

FIG. 13 is a perspective view of the absorbing body 270. Referring to FIG. 13, the absorbing body 270 may include holes 271, grooves 272, a first outer surface 273, and a second outer surface 274.

The holes 271 may be formed inside the absorbing body 270. A pair of holes 271 may be formed, through which the wire of the heater 162 may be inserted/withdrawn. A portion of the heater 162 and the insulating member 1621 may be disposed inside holes 271. The holes 271 may be formed straight. The holes 271 may extend in the longitudinal direction of the cartridge 140. The elongated holes 271 may be referred to as a tunnel or a channel.

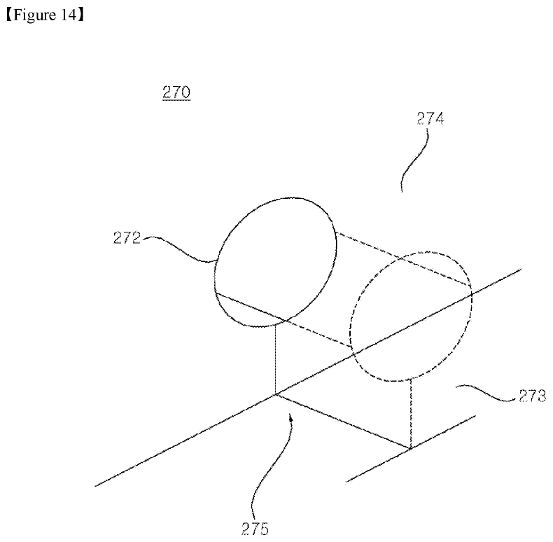

The grooves 272 may be formed outside the absorbing body 270. A plurality of grooves 272 may be formed to correspond to the plurality of protrusions 180. Each of the plurality of protrusions 180 may be inserted into each of the plurality of grooves 272. The grooves 272 may be formed in a lateral surface of the absorbing body 270. The grooves 272 may be connected to a cut portion 165 (see FIG. 14).

An outer surface of the absorbing body 270 may include a first outer surface 273 and a second outer surface 274. The second outer surface 274 of the absorbing body 270 may extend from the first outer surface 273 of the absorbing body 270 toward the container 142 to be connected to the container 142. The holes 271 may be formed in the first outer surface 273 of the absorbing body 270. The grooves 272 may be formed in the second outer surface 274 of the absorbing body 270.

The first outer surface 273 of the absorbing body 270 may be supported by the inner surface 1462 of the base 145. The second outer surface 274 of the absorbing body 270 may be supported by the inner surface 1461 of the base 145. The first outer surface 273 and the second outer surface 274 of the absorbing body 270 may have shapes, corresponding to the inner surfaces 1461 and 1462 of the base 145, to be supported by the inner surfaces 1461 and 1462 of the base 145. The outer surfaces 273 and 274 of the absorbing body 270 may be inserted into the inner surfaces 1461 and 1462 of the base 145.

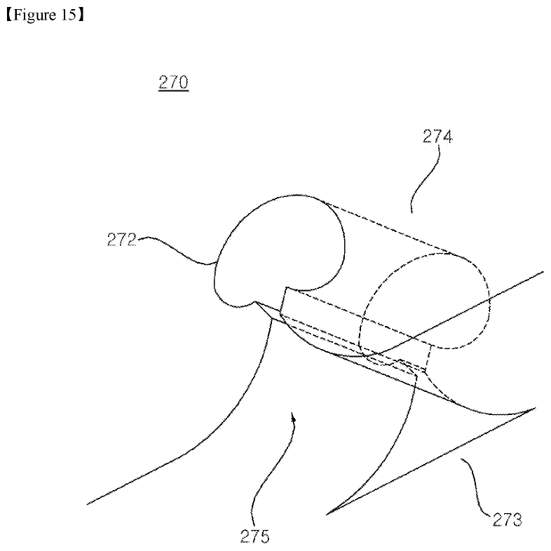

FIGS. 14 and 15 are perspective views illustrating a cut portion 275 of the absorbing body 270.

Referring to FIGS. 14 and 15, the cut portion 275 may be provided in a region where the first outer surface 273 and the second outer surface 274 of the absorbing body 270 meet each other. The cut portion 275 may be formed by cutting off a portion between the groove 272 and the first outer surface 273. The cut portion 275 may be integrally formed with the absorbing body 270. The cut portion 275 may be deformed by external pressure. That is, the cut portion 275 may be deformed by external pressure into shapes illustrated in FIGS. 14 and 15.

When the absorbing body 270 is installed in the base 145, the absorbing body 270 has a shape illustrated in FIG. 14. When the cut portion 275 is directed toward the inside of the base 145, and then the absorbing body 270 is inserted into the base 145, the cut portion 275 is deformed by contact with the protrusion into the shape illustrated in FIG. 15. When the absorbing body 270 is inserted into the base 145 such that the outer surfaces 273 and 274 of the absorbing body 270 are in contact with the inner surfaces 1461 and 1462 of the base 145, the protrusion 180 may be received in the groove 272, and the absorbing body 270 having the shape illustrated in FIG. 15 may return to its original shape, illustrated in FIG. 14, by its own elasticity.

Referring to FIGS. 1 to 7, an aerosol generating device 1 according to an embodiment of the present disclosure may include: a container 42 in which a liquid is contained between an inner wall 423 and an outer wall 422 surrounding the inner wall 423; an insertion space 426 which is disposed inside the inner wall 423 of the container 42 and is elongated; a wick 61 partially connected to an inside of the container and absorbing the liquid; a heater 62 heating the wick 61; a base 41 defining an inner space 414 that communicates with the insertion space 426, and formed at one side of the container 42 in a longitudinal direction of the insertion space 426; an inlet 412a communicating with the inner space 414 and formed in a side wall 412 of the base; and a filter 70 disposed on an inner surface of the side wall 412 of the base 41 and covering the inlet 412a.

According to another embodiment of the present disclosure, the insertion space 426 may include an opening 425 which is open to an outside, wherein the base 41 may include: a bottom 413 disposed opposite the opening 425 of the insertion space 426 with respect to the wick 61; and the side wall 412 disposed between the bottom 413 and the container 42 and extending from the bottom 413 toward the container 42, wherein the inlet 412a may be disposed closer to the container 42 than to the bottom 413.

According to another embodiment of the present disclosure, the inlet 412a may be open through the side wall 412 of the base 41 in a direction perpendicular to an inner surface of the base 41.

According to another embodiment of the present disclosure, the aerosol generating device 1 may further include a main body 50 provided with a power supply configured to supply power to the heater 62, wherein the base 41 may be detachably coupled to the main body 50.

According to another embodiment of the present disclosure, the base 41 and the container 42 may be integrally removed from the main body 50.

According to another embodiment of the present disclosure, the aerosol generating device 1 may further include a casing 30 coupled to the main body 50 and covering the container 42.

According to another embodiment of the present disclosure, the inner surface of the side wall 412 of the base 41 may be formed flat, and the filter 70 may be disposed on the inner surface.

According to another embodiment of the present disclosure, the base 41 may include a rib 412b protruding from the inner surface of the side wall 412, and extending along a circumference of the inlet 412a, wherein the filter 170 may be mounted to the rib 412b and may be spaced apart from the inlet 412a.

Referring to FIGS. 8 to 15, an aerosol generating device 11 according to an embodiment of the present disclosure may include: a container 142 having an inner wall 1423 which is elongated and defines an insertion space 1426 therein, and an outer wall 1422 surrounding the inner wall 1423 so that a liquid is contained between the inner wall 1423 and the outer wall 1422; a wick 161 disposed in the container 142 and partially connected or extending to the liquid contained between the inner wall 1423 and the outer wall 1422; a heater 162 disposed around the wick 161 and heating the wick 161; a base 141 disposed adjacent to the heater 162, coupled to the container 142, and having an inside communicating with the insertion space 1426; and a absorbing body 270 disposed in the base 141.

According to another embodiment of the present disclosure, the heater 162 may include a wire wound around an outer surface of the wick 161 and passing through the absorbing body 270 to be connected to a power source outside the container (not shown).

According to another embodiment of the present disclosure, the aerosol generating device 11 may further include an insulating member 1621 disposed between the absorbing body 270 and the wire, and covering the wire.

According to another embodiment of the present disclosure, the aerosol generating device 11 may further include a holder 190 protruding from an inner surface of the base 141 and supporting the absorbing body 270, wherein the absorbing body 270 may be disposed between the inner surface 1415 and 1416 of the base 141 and the holder 190.

According to another embodiment of the present disclosure, the holder 190 may press an outer surface of the absorbing body 270.

According to another embodiment of the present disclosure, the aerosol generating device 11 may further include a protrusion 180 protruding from the inner surface 1415 of the base and inserted into the absorbing body 270.

According to another embodiment of the present disclosure, the inner surface 1415 and 1416 of the base may include: a first inner surface 1416 facing the insertion space 1426; a second inner surface 1415 extending from the first inner surface 1416 toward the container 142 to be connected to the container 142; and an inlet 1412a formed in the second inner surface 1415 and allowing an inside and outside of the base 141 to communicate with each other, wherein the absorbing body 270 may be supported by the first inner surface 1416 and the second inner surface 1415.

According to another embodiment of the present disclosure, the absorbing body 270 may include: a first outer surface 273 supported by the first inner surface 1416 of the base 141; a second outer surface 274 supported by the second inner surface 1415 of the base 141; and a groove 272 which is formed on the second outer surface 274 and into which the protrusion 180 is inserted.

According to another embodiment of the present disclosure, the absorbing body 270 may include a cut portion 275 formed between the first outer surface 273 of the absorbing body 270 and the groove 272.

According to another embodiment of the present disclosure, the absorbing body 270 may be adhered to the inner surfaces 1415 and 1416 of the base 141.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol generating device comprising:
a container comprising an inner wall and an outer wall surrounding the inner wall and containing a liquid between the inner wall and the outer wall, wherein the inner wall is shaped to define an elongated insertion space;
a wick having a portion that is disposed between the inner wall and the outer wall to absorb the liquid;
a heater disposed around at least a portion of the wick and being configured to heat the wick;
a base defining an inner space that communicates with the insertion space and is disposed at one side of the container in a longitudinal direction of the insertion space, wherein the base includes a side wall that is shaped to define an inlet communicating with the inner space of the base; and
a filter disposed inside the base and covering the inlet.

2. The aerosol generating device of claim 1, wherein the inner wall is shaped to define a first opening at one end and a second opening at another end, wherein the first opening is open to an outside of the aerosol generating device,
wherein the base couples to the container adjacent to the second opening of the inner wall, and wherein the base comprises a bottom,
wherein the side wall is disposed between the bottom and the container and extends from the bottom toward the container, and
wherein the inlet is disposed closer to the container than to the bottom.

3. The aerosol generating device of claim 2, wherein the inlet is formed to horizontally pass through the side wall of the base.

4. The aerosol generating device of claim 1, further comprising a main body having a power supply configured to supply power to the heater to enable the heater to heat the wick,
wherein the base is detachably coupled to the main body.

5. The aerosol generating device of claim 4, further comprising a casing coupled to the main body and covering the container.

6. The aerosol generating device of claim 1, wherein the inner surface of the side wall of the base is flat, and the filter is disposed on the inner surface.

7. The aerosol generating device of claim 1, wherein the base comprises a rib protruding from the inner surface of the side wall and extending relative to a circumference of the inlet,
wherein the filter is coupled to the rib and is spaced from the side wall of the base.

8. An aerosol generating device comprising:
a container including an elongated inner wall that is shaped to define an insertion space, and an outer wall surrounding the inner wall and being shaped to contain a liquid between the inner wall and the outer wall;
a wick having a portion that is disposed between the inner wall and the outer wall;
a heater disposed around at least a portion of the wick and being configured to heat the wick;
a base disposed adjacent to the heater and coupled to the container, an inside of the base communicating with the insertion space; and
an absorbing body disposed in the base.

9. The aerosol generating device of claim 8, wherein the heater comprises a wire wound around an outer surface of the wick and passing through the absorbing body to be connected to a power supply located outside the container.

10. The aerosol generating device of claim 9, further comprising an insulating member disposed between the absorbing body and a portion of the wire which passes through the absorbing body, the insulating member covering the portion of the wire.

11. The aerosol generating device of claim 8, further comprising a holder protruding from an inner surface of the base and supporting the absorbing body,
wherein the absorbing body is interposed between an inner surface of the base and the holder.

12. The aerosol generating device of claim 8, further comprising a protrusion protruding from an inner surface of the base and inserted into the absorbing body.

13. The aerosol generating device of claim 12, wherein the inner surface of the base comprises:
a first inner surface facing the insertion space;
a second inner surface extending from the first inner surface toward the container; and
an inlet formed in the second inner surface and enabling communication between an inside and outside of the base,
wherein the absorbing body is supported by the first inner surface and the second inner surface.

14. The aerosol generating device of claim 13, wherein the absorbing body comprises:
a first outer surface supported by the first inner surface of the base;
a second outer surface supported by the second inner surface of the base; and
a groove which is formed on the second outer surface and into which the protrusion is received.

15. The aerosol generating device of claim 14, wherein the absorbing body comprises a cut portion formed between the first outer surface of the absorbing body and the groove.
